(19) United States
(12) Patent Application Publication
(10) Pub. No.: US 2006/0168106 A1
(43) Pub. Date: Jul. 27, 2006

(54) Method for reducing latency periods during interactive data communication between a terminal server and a terminal server client in a geostationay satellite network

(75) Inventors: Klaus Rock, Aalen (DE); Ute Rock, Aalen (DE)

Correspondence Address: LERNER GREENBERG STEMER LLP, P O BOX 2480, HOLLYWOOD, FL, 33022-2480, US

(73) Assignee: Rock Technologies Limited

(21) Appl. No.: 10/551,851

(22) PCT Filed: Apr. 2, 2004
(86) PCT No.: PCT/EP04/03500

§ 371 Date: Nov. 14, 2005

(30) Foreign Application Priority Data
Apr. 2, 2003 (DE) 103 15 111.7

(51) Int. Cl. G06F 15/16

(52) U.S. Cl. 709/218; 709/203

(57) ABSTRACT

A method for reducing the latency time for interactive data communication between a server computer (6) and a client computer (2) via a satellite network (4) comprising a geostationary satellite (12), whereby a data processing application (14), in particular a database application, runs on the server computer (6) and generates screen displays of an interactive user application with several data fields (18) that are processed one after the other in a processing sequence in line with predetermined parameters (#1, #2, #3) based on commands and data entered via an input medium (30) connected to the client computer (2), and then transferred to the client computer (2) in the form of data packets essentially without acknowledgment of receipt and displayed by this client computer (2) on a display medium (26), whereby an input prompt (7) on the display medium (26) signalizes that additional data is to be entered in a corresponding data field (18) via the input medium and then transferred in the form of additional data packets via the telecommunication network (4) to the server computer (6), wherein the parameters (#1, #2, #3) for the processing sequence of the data fields (18) are transmitted via the satellite network (4) to the client computer (2); and an independent program routine (22), which runs on the client computer (2), alters the screen display independently in such a way when entering specified commands via the input medium (30, 32) based on the parameters (#1, #2, #3) for the processing sequence that the input prompt (7) within a data field (18) is moved to the next or previous data field in line with the processing sequence.

### BACKGROUND INFORMATION

The present invention relates to a method for reducing the latency time for interactive data communication between a server computer and a client computer connected via a geostationary satellite network, according to the preamble of claim 1.

The data communication via satellite networks preferably employs geostationary satellites positioned at a distance of approximately 36,000 km above the surface of the Earth and moving in conjunction with the Earth while maintaining an essentially fixed position in relation to the Earth's surface. As a result, when observed from the Earth it appears as if the satellite remains stationary above the area of the Earth's surface situated directly below the satellite and within which communication with the satellite is possible. This area is often referred to as the “footprint”.

There are now a number of satellites in orbit around the Earth which line up practically like gems on a necklace at a distance of approximately 36,000 km above the equator.

Due to their high bandwidth and transfer security, satellite connections are well suited to transferring large volumes of data, such as analog and digital television programs, videos and Internet downloads, as these types of transfer do not require any interactive acknowledgments of receipt via satellite.

This mass data is transmitted as a continuous data stream to the geostationary satellites via so-called satellite HUBS (uplinks) and servers connected to these. From here it is then distributed to a number of satellite reception installations in the area of the footprint of the satellites.

Because of this great distance and the finite propagation speed of electromagnetic signals, data communication via geostationary satellites is a problem, in that the delay of electromagnetic signals from a transmitter on the Earth to the satellite and from there to the receiver is around 0.24 seconds, so that an answer sent by the receiver without any time delay will not reach the transmitter until approximately 0.7 to 2 seconds later at the earliest due to additional electronic loss of time during signal conversion.

For interactive data communication between a client computer and a server computer, where the server computer undertakes the actual data processing and the client computer simply assumes the function of an intelligent terminal, producing for the user of the client computer an interactive screen display using the data transferred by the server computer via the geostationary satellite, this inevitable time delay, often described as latency time, means that a character entered by the user of the client computer, for example via a keyboard or a movement of the mouse, is acknowledged on the screen of the client computer by a corresponding echo from the server computer after one or two seconds at the earliest. Although the inventive method can, in principle, be used for all known telecommunication networks, it is used predominantly for satellite networks. The following description is therefore based on satellite applications.

Because this time delay of approximately 0.7 to 2 seconds, which occurs for each user input via the keyboard, mouse or other data input device of the client computer, is unacceptable for interactive data communication, interactive client-server applications (such as ASP software with data-driven applications, which are, for example, of benefit in terrestrial connections with a large number of users and can be undertaken with the aid of operating systems such as UNIX or Windows 2000 Server etc.) are generally not practicable via geostationary satellites.

One particular problem is that great time lags occur with database applications running on the server computer, where the data entries are made in corresponding data fields or data entry boxes, which are displayed on the client computer in the form of an interactive user application and are executed one after the other in a predetermined sequence, where numbers and letters are entered into the individual fields or where the user switches from one data field to the next. These time lags make working with such systems in practice laborious or even impossible.

The non-prepublished DE-A-102 00 165 by the patent applicant indicates the intention to reduce the latency time for interactive data communication between a client computer and server computer, connected to one another via a satellite network containing geostationary satellites, and thereby accelerate an interactive user application running on the client computer by making the transfer of the data packets from the client computer to the server computer and/or back essentially take place without acknowledgments of receipt.

WO 01/08378 A1 also suggests accelerating the visual response behavior of a client computer within a client-server system operated via a terrestrial network by having the client computer generate with every data entry a predicted display of the screen contents to be output on the screen of the client computer before the actual screen generated by the server computer based on the data entered is transferred from the server computer to the client computer for display on the client screen.

Alongside the fact that the publication does not contain any specific details on how and on the basis of which parameters the advance calculation or prediction of the expected display of the screen contents is to take place, the publication also does not give any indication to use the method described there on a network where the data is transferred via a geostationary satellite essentially without acknowledgments of receipt to further reduce the latency time physically caused by the signal transfer times—which is significantly greater than the delay caused by the utilization of the server computer—when entering data in data fields on the client computer.

### BRIEF SUMMARY OF THE INVENTION

Accordingly, one object of the present invention is to provide a method which can be used to further increase the speed of interactive user applications provided on the screen of a client computer by a server computer connected via a telecommunication network where data entry in predetermined data fields takes place.

According to the invention a server computer and a client computer are connected to one another for data exchange via a telecommunication network, which in particular contains a geostationary satellite. On the server computer an interactive data processing program is executed, for example a database application, a spreadsheet application, a text processing application or a program for creating e-mails, where a user of the client computer enters data via an input medium connected to the server computer.

Here, the data is entered in data fields of a form (GUI), whereby the position in which the data, for example numbers, letters or other characters, are entered within a data field is indicated on the screen of the client computer by an input prompt such as a cursor. In the case of a database application or a spreadsheet application, the data fields should preferably match the input fields or the table of the database input mask shown on the screen, whereas the data fields for a text processing or e-mail program can, for example, match a full text line.

As is typical with such applications, the data fields are processed in a sequence predefined by specified parameters, whereby the user makes an entry in a field and then confirms this entry ready to move to the subsequent field. This confirmation command can, for example, be made by hitting the “RETURN” or “TAB” key or by using one of the arrow buttons etc. on a keyboard and leads to the input prompt moving to the next or previous data field.

The data input fields are typically transferred as data packets via the network to the client computer using a type of client-server connection where the execution and graphic display of the data processing application takes place solely on the server computer and the client computer merely performs the function of an intelligent terminal, via which the graphic displays are merely displayed to the user in the form of an interactive user application. These displays are shown on a screen or any other visual display medium on the client computer using a dedicated processor and a corresponding graphics card. The entry of additional data in a data field is signalized by the input prompt, which is located in the corresponding position within a data field where additional data is to be entered.

Using the inventive method the transfer of data and/or commands entered via the input medium on the client computer takes place via the satellite network in the form of additional data packets from the client computer to the server computer essentially without an acknowledgment of receipt of the transmitted additional data packets by the server computer. Once the server computer has received the packages via the geostationary satellite, it then uses this newly entered data when running the data processing application to generate a new screen display, which in turn is transferred in the form of data packets to the client computer, which itself uses these data packets to visualize the new screen content using its own graphics card and display medium.

The inventive method is distinguished by the fact that the parameters for the processing sequence of the data fields are also transmitted via the satellite network to the client computer and that an independent program routine runs on the client computer which changes the screen display based on the parameters for the processing sequence in such a way when entering specified commands via the input medium that the input prompt within a data field is moved to the next or previous data field in line with the processing sequence.

The inventive method offers the advantage that the data entry can be performed centrally from a large number of client computers, which can practically be distributed over the entire footprint of the geostationary satellite, and at a speed which can otherwise only be achieved with interactive data entry via a terrestrial data network, where the physical time lags or latency times are multiple times lower than is the case with geostationary satellite connections.

Alongside their low purchasing, operating and maintenance costs, intelligent terminals, connected via a geostationary satellite to the server computer, also offer the advantage that it is either impossible or very difficult to perform major data manipulations to the data of the server computer from the actual client computer if the client computer does not have any additional devices for data transfer, such as interfaces for mass memory storage devices or network interfaces.

The transfer of data via a geostationary satellite in connection with server-based data processing, otherwise only found with terrestrial networks, where the data processing application as such runs solely on the server computer and only the relevant screens are transferred to the client computer for display, further offers the advantage that the data packets can be sent from the server computer to the client computer and vice versa essentially without acknowledgments of receipt and therefore without the problem of the data processing application crashing on the server computer.

This is, for example, generally not the case with HTML-based applications, where the HTML pages are downloaded from a web server and then displayed using a complex browser software running on the client computer, since the HTML code is interpreted or compiled by the browser software, whereby the browser software itself is prone to crashing in the event of errors in the transmitted data.

Yet with the inventive method, this kind of data loss merely leads to an imprecise portrayal of the data field that has just been processed, since only the altered sections of the screen display should preferably be transmitted, to then be corrected the next time a character or command is entered, when the server computer calculates and then transmits the next screen display to the client computer, for example after 2 seconds.

According to the preferred embodiment of the invention, the server computer is operated using a window-based operating system, whereby the screen display transmitted to the client computer is generated on the server computer using a window program routine of the operating system in place on the server computer based on window and object parameters prior to being sent to the client computer. The preferred window-based operating system is Windows 2000, 2003 or 200X Server offered by the Microsoft Corporation, where the data processing applications for each of the client computers connected to the server computer run on a virtual desktop in the memory of the server computer. In this manner the actual display of the window displays generated by a corresponding data processing application is controlled by the so-called Window Manager, whereby each object that is to be displayed by a data processing application on the screen of the client computer is created on the virtual desktop and administrated by the Window Manager. In this manner each object, for example the data fields, scroll bars, buttons and also the windows and frames of these objects themselves, is then described by the Window Manager based on the accompanying parameters, whereby the parameters for displaying the data fields can, for example, also include the position of the data field on the screen, the font, the font size and the position of the cursor etc. alongside the numbering, which lays down the processing sequence either directly or indirectly.

With the inventive method the parameters for the processing sequence of the data fields are used by the independent program routine within the Window Manager to accelerate the screen display on the client computer when entering data in the data fields.

To do this, a copy or at least a partial copy of the window and object parameters is created, for example by an additional program routine running on the server computer which accesses the operating system. The window program routine of the operating system on the server computer—in the case of Windows 200X Server, the Window Manager—then uses this copy or partial copy to generate the active screen display of the data processing application currently running. This copy or partial copy of the Window Manager, which due to the object-oriented description has a small size compared to a purely pixel-based graphic, is then sent via the geostationary satellite network to the client computer and read by this computer's independent program routine.

The client computer's independent program routine analyzes the commands and/or data entered via the input medium before sending these to the server computer, for example using familiar “IF-THEN” inquiries, and independently changes the active display on the screen of the client computer by accessing the graphics memory of the client computer based on the processing sequence as well as the window and object parameters in the copy of the Window Manager to the effect that, for example, when pressing the “ENTER” key or “Down arrow” key, the input prompt is positioned at the start of the data field having the next ID number. The advantage with this method is that only the data field the user has just jumped to is altered, without the entire screen display having to be recalculated by the client computer.

In the same way, the client computer's program routine independently changes the active screen display based on the processing sequence as well as the window and object parameters to the effect that the input prompt is positioned at the start of the previous data field when a defined command which triggers a backwards jump to a previous data field occurs, such as “Up arrow” for example.

The local alteration of the corresponding data field due up next in line with the sequence determined by the Window Manager offers a fluid interactive display on the screen despite the comparatively long physical latency time of 0.7 to 2 seconds.

As the patent applicant discovered, this can also surprisingly be ascribed to the fact that with the operating systems described in the case of data transfer via terrestrial data networks the acknowledgments of receipt required to safely receive the transmitted data due to the high susceptibility to errors and routing requirements essentially disappear or can at least be reduced to an absolute minimum, since the transfer of the data transfer via geostationary satellites has only an extremely low susceptibility to errors.

However, should a data packet go missing during transmission from the server computer to the client computer due to the missing acknowledgments of receipt when sending commands and data, this just leads to inaccurate information being displayed briefly, which is then automatically corrected on the screen of the client computer after a short time when the server computer transmits an updated display.

According to a further embodiment of the basic inventive concept, it is also conceivable that the independent program routine can analyze the position of a data pointing device assigned to the input medium, in particular a mouse pointer, and independently change the display of the corresponding object in the active screen display in a predefined manner when the position of the data pointing device corresponds to a predefined position or a section in the active screen display. The object here should preferably be a button whose appearance changes, for example turning brighter or being altered graphically in some other manner, when the mouse pointer is located in the section of the button, to let the user know that the button is activated when a command is entered.

A further increase in the execution speed of the interactive user application on the client screen can also be achieved by having the independent program routine simultaneously monitor whether a command, in particular a mouse click, is entered. An example of this kind of object is a familiar scroll bar, whose display is altered in a predefined manner and which causes at least a part of the content of the active screen display to be moved when clicked on by the user with the data pointing device. The movement of the screen display should preferably take place by the entire content of the screen display, defined by the copy of the Window Manager in the client computer, being moved in the standard manner in the memory of the graphics card on the client computer before the screen display is recalculated by the server computer and the updated version sent back to the client computer. As the parameters from the copy of the Window Manager on the client computer are used, the locally generated screen display to a great extent matches the screen display calculated by the server computer and sent by the server computer to the client computer via the geostationary satellite with a time lag of 0.7 to 2 seconds in the case of operations which have not caused any changes to the screen display on the server computer by the data processing application. The locally generated display is then ultimately overwritten by the display received from the server computer, which is the binding display.

The screen displays should preferably be transferred via a correspondingly designed protocol, for example RDP, and can include uncompressed or compressed bitmap files, which are transferred to the client computer. According to the preferred embodiment of the invention, preferably only the part of the screen display that has changed relative to the previous display is transmitted via the geostationary satellite.

In this manner the system has the advantage that the data volume transferred via the satellite network and the actual number of transfers—often referred to as traffic—can be drastically reduced, in particular in combination with a transfer without or essentially without acknowledgments of receipt.

According to a further embodiment of the invention, the additional data packets sent from the client computer to the server computer are also transferred essentially without acknowledgment of their receipt by the server computer, which in turn further drastically reduces the volume of traffic, while allowing the interactive application to run faster on the screen of the client computer for the user. So it is, for example, possible for an acknowledgment of receipt only to be assigned to commands which trigger a high level computer activity on the server computer, for example an extensive resorting of data stocks, to ensure no unnecessary waiting times are generated.

As the patent applicant has further discovered, not only does omitting acknowledgments of receipt bring significant speed advantages when transferring data packets from the server computer to the client computer, it has been also observed that this reduction in the number of acknowledgments of receipt when transferring additional data packets in the other direction from the client computer to the server computer does not bring about any appreciable restrictions for the user of data processing applications described above.

A further reduction of the data volumes transferred via the satellite network can be achieved using the inventive method by having the additional data packets checked for redundant data and then having any such redundant data removed or replaced by data already entered before they are sent to the server computer.

In the same manner the data packets generated by the server computer can also be checked for redundant data before being sent to the client computer, with any redundant data found being removed from the data packets or replaced by data held on the server computer.

According to a further embodiment of the invention, wherein optimum use is made of the bandwidth available on the satellite network, several of the data packets transferred between the server and the client computer via the geostationary satellite and/or additional data packets can be grouped together to form large data packets and/or large additional data packets, whereby the grouped large data packets and/or the grouped large additional data packets have an optimized size in such a way that their transfer via the geostationary satellite takes place without the data packets and/or additional data packets being fragmented.

The optimized size of the large data packets and/or the large additional data packets should preferably be determined by the server computer when setting up the satellite network for the corresponding connections to the client computer based on the connection-specific parameters.

This allows the latency time to be further reduced, thereby offering an advantage when working with interactive applications on the described client-server networks.

### BRIEF DESCRIPTION OF THE DRAWING

In the following, the invention is described by way of a preferred embodiment with reference to the accompanying drawing in which:

FIG. 1 shows a schematic representation of a satellite network according to the invention with the accompanying computer components and program routines to illustrate the working method of the inventive process.

### DETAILED DESCRIPTION

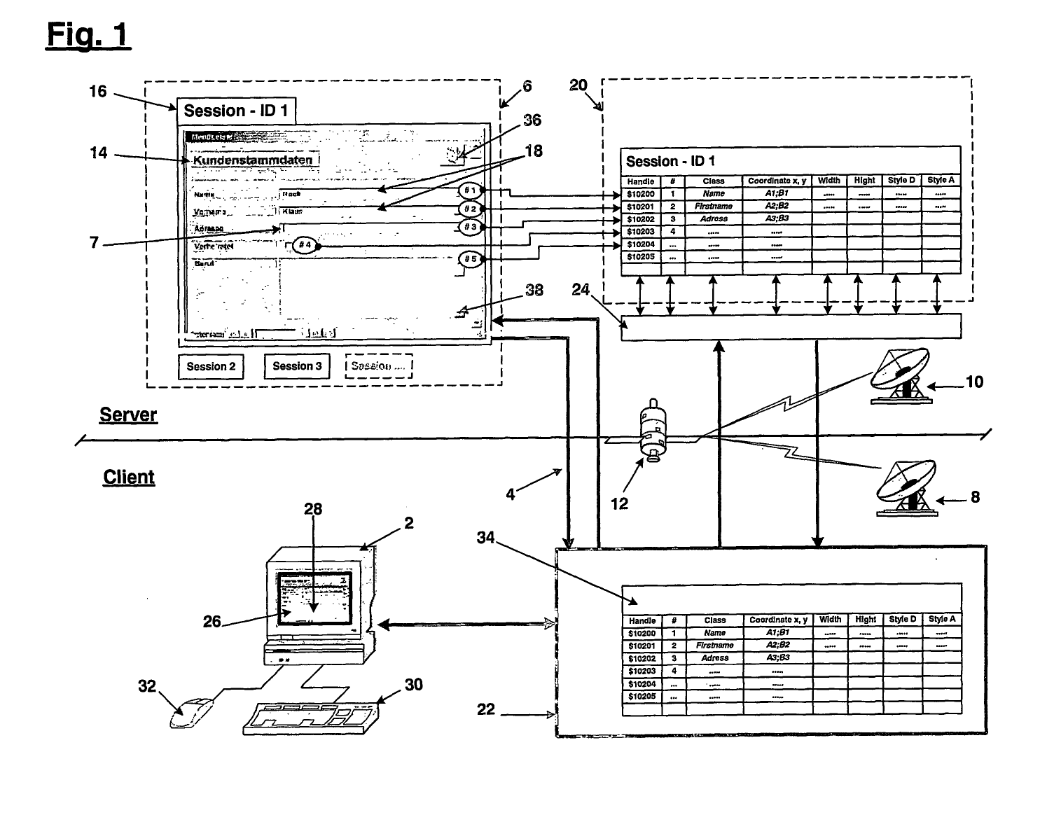

As FIG. 1 shows, a client computer 2 is connected via a satellite network 4 to a server computer 6, which for display reasons is indicated in the figure simply in broken lines.

The satellite network 4 comprises a first client-based ground station 8 as well as a server-based ground station 10, which are connected to one another via a geostationary satellite 12 for data exchange purposes.

Depending on the number of client computers 2 connected to the server computer 6, this server computer 6 can run one, two or several data processing applications 14, which run separately on a virtual desktop in associated closed sessions 16 on the server computer 6.

To make the illustration clearer and easier to understand, in this case only a single data processing application 14 is shown. This is used for entering customer master data, which is filled out with corresponding data based on a predefined processing sequence using an input prompt 7, as is typical of form processing applications, text processing applications or spreadsheet applications. The processing sequence of the data fields 18, their position, width, height and also the type of font used therein is controlled by a window program routine 20 of the operating system running on the server computer 6.

Here, the window program routine 20 should preferably contain in tabular form all window and object parameters which are needed to generate the screen display of the data processing application 14 on the virtual desktop of the server computer 6.

As can also be seen in FIG. 1, each data field 18 is assigned an accompanying allocation number #1, #2, #3, etc., which specifies the parameter for the processing sequence of the data fields 18.

On the client computer 2 an independent program routine 22 runs, which receives a copy or partial copy of the window program routine 20 or the window and object parameters used therein from an additional program routine 24 on the server computer 6 via the satellite network 4 for displaying the windows and objects, the latter of which can, for example, contain buttons 36 or scroll bars 38 as well as the data fields 18 themselves. Here, the transfer of the copy or partial copy 34 of the window and object parameters of the window program routine 20 should preferably take place when the data processing application 14 is launched on the server computer 6 as well as when changing to a fully new screen display after this has been generated by the data processing application 14.

The screen display of the data processing application generated on the server computer 6 using the window program routine 20 is then sent via the satellite network 4 to the client computer 2 in the form of data packets essentially without acknowledgment of receipt and then displayed on the screen 26 of the client computer 2 in the form of an interactive user application, as indicated in the drawing by the arrow 28. The client computer 2 is also equipped with a data input medium in the form of a keyboard 30 and a data pointing device in the form of a mouse 32, via which data and commands are entered by the user, which are then sent from the client computer 2 as additional data packets via the satellite network 4 to the server computer 6. The data processing application 14 takes the additional data packets and generates a new, updated screen display of the interactive user application, which is then sent back (again in the form of data packets in line with the familiar RDP protocol) via the satellite network 4 to the client computer 2, to update those parts of the display of the interactive user application on the screen 26 which were changed last by the data processing application 14.

To reduce time lags due to the physical transfer latency time of 0.7 to 2 seconds when entering data in the data fields 18, the commands and data entered via the keyboard 30 or mouse 32—which are generally entered as ASCII characters—are analyzed by the independent program routine 22 running on the client computer 2, with the input prompt 7 being moved on locally in accordance with the corresponding command or character, while the commands and/or characters are transferred with the intrinsic delay via the satellite network 4 to the server computer 6, processed by the server computer 6 and then sent back to the client computer 2 as updated screen displays.

If the input prompt 7 is, for example, located in data field 18 with the allocation number #3, the independent program routine 22 detects this based on the copy or partial copy 34 of the window and object parameters. If the command “Up arrow” is entered, for example by the user on the keyboard 30 by pressing the corresponding button, this is detected by the independent program routine 22 based on a corresponding inquiry. In the copy 34 of the window and object parameters the accompanying parameters for the previous data field 18 with the allocation number #2 are then read.

Without waiting for the new and updated screen display of the active user application to arrive from the server computer 6 due to the command initiated, the independent program routine 22 is used to transfer the object parameters for the position, width, height and font, etc. assigned to the data field 18 with the allocation number #2 to the operating system of the client computer 2, which in turn controls the graphics card of the client computer in the familiar manner with corresponding commands to alter the display of the second data field 18 assigned the allocation number #2 on the screen 26 to the effect that the command prompt 7 is moved to the left-hand edge of the data field so that the keyboard 30 can be used to enter additional data.

Once the updated screen display of the interactive user application has been calculated by the server computer 6 and sent to the client computer 2 via the satellite network 4 after the certain time lag, for example of 1 to 2 seconds, the locally generated screen display of the interactive user application is replaced on the screen 26 by the new screen display calculated by the server computer 6. As already described, preferably only the altered parts of the screen display should be overwritten here.

In a corresponding manner the independent program routine 22 moves the command prompt 7 to the start of the data field 18 with the next higher allocation number #4 in the manner already described by checking the copy or partial copy 34 of the window and object parameters when an additional command is entered, for example when the “ENTER” or “TAB” key is pressed.

It is also conceivable that the window program routine 22 on the server computer 6 also contains objects of the screen display (controls), which, as shown in FIG. 1, can be buttons 36 or scroll bars 38 that can be activated with the mouse 36 and which should preferably also be transferred via the satellite network 4 to the client computer 2 in the form of a copy or partial copy 34 of the window and object parameters.

In the preferred embodiment of the invention the independent program routine 22 also monitors the position of the mouse pointer, and alters items such as the style or display type of the button 36 when the position of the mouse pointer corresponds to the section on the screen 26 where the button 36 is located. To achieve this it is conceivable that the independent program routine 22 compares the x and y coordinates of every object in the copy 34 of the window and object parameters with the current mouse position and searches for the other object parameters in the copy 34 of the window and object parameters if the coordinates match, for example by reading the associated line of an assigned table.

If the object 36 is to be activated by clicking on it with the mouse 32, for example to exit the entry mask, this can be signalized by the generation of an acoustic signal, generated locally by the additional program routine 22. In the same manner it is possible to further accelerate the display of the interactive user application by keeping a copy of the window and object parameters of the previous screen display of the interactive user application in the memory of the client computer 2, which is read by the independent program routine when the button 36 is clicked or a corresponding command is entered via the keyboard 30, for example to bring up a local display of the screen display of a higher level of the data processing application 14, from which the user jumped to the mask shown in FIG. 1 before this display is calculated by the server computer 6 and sent via the satellite network 4 to the client computer 2 (with the unavoidable delay) for viewing on the screen 26.

Ultimately, when the mouse is used to click on the scroll bar 38, a subroutine running on the operating system of the client computer 2 can be called up to move the entire screen display based on the specifications of the copy 34 of the window and object parameters by manipulating the content of the memory of the graphics card of the client computer 2 in the standard, familiar manner.

### LIST OF REFERENCE NUMBERS

2 Client computer
4 Satellite network
6 Server computer
7 Input prompt
8 Client-based ground station
10 Server-based ground station
12 Geostationary satellite
14 Data processing application
16 Session on the server
18 Data field
20 Window program routine
22 Independent program routine
24 Additional program routine
26 Screen
28 Arrow
30 Keyboard
32 Mouse
34 Copy/partial copy of the window and object parameters on the client computer
36 Button
38 Scroll bar
#1, #2, #3 allocation numbers

1-21. (canceled)

22. A method for reducing the latency time for interactive data communication between a server computer and a client computer via a telecommunication network, in particular via a satellite network comprising a geostationary satellite, wherein a data processing application, in particular a database application, runs on the server and generates screen displays of an interactive user application with several data fields that are processed one after the other in a processing sequence in line with predetermined parameters based on commands and data entered via an input medium connected to the client computer and are then transferred to the client computer in the form of data packets essentially without acknowledgment of receipt and displayed by this client computer on a display medium, whereby on the display medium a command prompt signalizes that additional data is to be entered in a corresponding data field via the input medium, and then transmitted in the form of additional data packets via the telecommunication network to the server computer, wherein the parameters for the processing sequence of the data fields are transferred via the telecommunication network to the client computer, and an independent program routine runs on the client computer which alters the screen display independently in such a way when entering specified commands via the input medium based on the parameters for the processing sequence that the input prompt within a data field is moved to the next or previous data field in line with the processing sequence.

23. The method according to claim 22, wherein the server computer is operated using a window-based operating system, whereby the screen displays transmitted to the client computer are generated on the server computer using a window program routine of the operating system on the server computer based on window and object parameters prior to being sent to the client computer.

24. The method according to claim 23, wherein the independent program routine receives the parameters for the processing sequence of the data fields by accessing the window program routine of the operating system on the server computer.

25. The method according to claim 23, wherein the independent program routine receives a copy or partial copy of the window and object parameters which the window program routine of the operating system on the server computer uses to generate the active screen display.

26. The method according to claim 22, wherein the independent program routine additionally receives the type and/or style and/or size of the font used in a data field alongside the parameters for the processing sequence of the data fields.

27. The method according to claim 23, wherein the independent program routine receives the parameters for the processing sequence of the data fields and/or the window and object parameters from an additional program routine running on the server computer.

28. The method according to claim 23, wherein the independent program routine analyzes the commands and/or data entered via the input medium before sending these to the server computer and independently alters the active screen display based on the processing sequence and the window and object parameters.

29. The method according to claim 28, wherein the independent program routine independently alters the active screen display based on the processing sequence as well as the window and object parameters in such a way that the input prompt is moved to the start of the previous data field when a specified command occurs which is assigned to a backward jump to a previous data field.

30. The method according to claim 28, wherein the independent program routine independently alters the active screen display based on the processing sequence as well as the window and object parameters in such a way that the input prompt is moved to the start of the next data field when a specified command occurs which is assigned to a forward jump to a previous data field.

31. The method according to claim 22, wherein the independent program routine analyzes the position of a data pointing device assigned to the input medium, in particular a mouse pointer, and independently alters the display of an object contained in the active screen display in a predefined manner when the position of the data pointing device corresponds to a predefined position or a section in the active screen display.

32. The method according to claim 28, wherein the independent program routine independently alters the display of the object contained in the active screen display in the predefined manner when the position of the data pointing device corresponds to a predefined position or a section in the active screen display and a predefined command is entered essentially simultaneously via the input medium.

33. The method according to claims 32, wherein the object is a button which changes the display types when the user clicks on it with the data pointing device.

34. The method according to claim 32, wherein the object is a scroll bar and when clicked on by the user with the data pointing device, the display of the scroll bar is altered in a predefined manner and at least a part of the content of the active screen display is moved.

35. The method according to claim 22, wherein the screen displays are transmitted at least in part in the form of bitmap files to the client computer.

36. The method according to claim 22, wherein the transfer of the screen displays takes place in line with the RDP protocol.

37. The method according to claim 22, wherein the transfer of the additional data packets from the client computer to the server computer takes place essentially without acknowledgments of receipt of the additional data packets being sent by the server computer.

38. The method according to claim 22, wherein the additional data packets are checked for redundant data, with any such redundant data then being removed or replaced by data already entered, before they are sent to the server computer.

39. The method according to claim 22, wherein the data packets generated by the server computer are checked for redundant data, with any such redundant data then being removed or replaced by data kept by the server computer before they are sent to the client computer.

40. The method according to claim 22, wherein several of the data packets and/or additional data packets to be sent between the server computer and the client computer via the geostationary satellite are grouped together to form larger data packets and/or larger additional data packets.

41. The method according to claim 40, wherein the grouped larger data packets and/or the grouped larger additional data packets have an optimized size in such a way that their transfer via the geostationary satellite takes place without the data packets and/or additional data packets being fragmented.

42. The method according to claim 41, wherein the optimized size of the larger data packets and/or the larger additional data packets is determined based on the connection-specific parameters by the server computer when setting up the satellite network for the corresponding connection to the client computer.
